(19) United States
(12) Patent Application Publication
(10) Pub. No.: US 2026/0210718 A1
(43) Pub. Date: Jul. 23, 2026

(54) RECURSIVE INERTIAL PREDICTOR

(71) Applicant: Analog Devices, Inc., Wilmington, MA (US)

(72) Inventors: Alan Christopher OCONNOR, Dedham, MA (US); Glenn M. ROMANO, Greensboro, NC (US); Michael R. PRICE, Medford, MA (US); Sundara Ganesh PALANI, Belmont, MA (US)

(21) Appl. No.: 19/033,258

(22) Filed: Jan. 21, 2025

(51) Int. Cl. G01C 21/16; B60W 50/00

(52) U.S. Cl. CPC G01C 21/16; B60W 50/0097; B60W 2050/0028

(57) ABSTRACT

In an aspect, a system for managing object stability is provided. A first set of one or more processors, individually or in combination, are configured as a sensor data fuser, to combine inertial data of an inertial measurement unit (IMU) associated with an object and aiding sensor data of one or more aiding sensors associated with the object to output fused sensor data at a first latency time representative of a specified base state at a specified base time by extrapolating a kinematic state of the object from the specified base state at the specified base time to a time of a new inertial data element. The extrapolating includes recursively extending or contracting an extrapolation horizon.

### TECHNICAL FIELD

Aspects of the present disclosure relate generally to inertial navigation systems (INS) and, more particularly, to a recursive inertial predictor in an INS.

### BACKGROUND

To maintain closed-loop vehicle stability, autonomous vehicle manufacturers have expressed a strong desire for an inertial navigation system for autonomous vehicles that provides position, velocity and attitude estimates with a latency under 10 ms.

The existing approaches for estimating position, velocity and attitude offer different tradeoffs between accuracy, latency, and computational complexity. However, there is a need for an improved approach to addressing latency in an INS.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of managing object stability is provided. The method includes combining, by a first set of one or more processors, individually or in combination, configured as a recursive inertial predictor (RIP), inertial data of an inertial measurement unit (IMU) associated with an object and a specified base kinematic state of the object at a specified first time, wherein the combining includes performing an extrapolation to produce an inertially-extrapolated kinematic state of the object at a second time. The extrapolation includes recursively extending or contracting an extrapolation horizon.

In another aspect, a system for managing object stability is provided. The system includes a first set of one or more processors, individually or in combination, configured as a sensor data fuser, to combine inertial data of an inertial measurement unit (IMU) associated with an object and aiding sensor data of one or more aiding sensors associated with the object to output fused sensor data at a first latency time representative of a specified base state at a specified base time by extrapolating a kinematic state of the object from the specified base state at the specified base time to a time of a new inertial data element. The extrapolating includes recursively extending or contracting an extrapolation horizon.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram of an example inertial navigation system (INS), in accordance with an exemplary aspect.

FIG. 2 is a diagram of example plots of actual vehicle positions relative to sensor data fuser vehicle position estimates and sensor data fuser forward predicted vehicle prediction estimates in accordance with an exemplary aspect.

FIG. 3 is a block diagram of an example of the recursive inertial predictor (RIP) of FIG. 1, in accordance with an exemplary aspect.

FIG. 4 is a block diagram of another example of the RIP of FIG. 1, in accordance with an exemplary aspect.

FIG. 5 is a block diagram of yet another example of the RIP of FIG. 1, in accordance with an exemplary aspect.

FIG. 6 is a flow diagram of an example method performed by the RIP of FIG. 3, in accordance with an exemplary aspect.

FIG. 7 is a flow diagram of an example method performed by the RIP of FIG. 4, in accordance with an exemplary aspect.

FIG. 8 is a flow diagram of an example method performed by the RIP of FIG. 5, in accordance with an exemplary aspect.

FIG. 9 is a flow diagram of an example method for managing object stability, in accordance with an exemplary aspect.

FIG. 10 is a flow diagram of an example method for controlling object movement responsive to inertially-extrapolated kinematic state estimates, in accordance with an exemplary aspect.

### DETAILED DESCRIPTION

The present disclosure is directed to a recursive inertial predictor (RIP) in an inertial navigation system (INS). In an aspect, an INS includes a RIP and a sensor data fuser. In an aspect, the sensor data fuser can be implemented by an extended Kalman filter (EKF).

In an aspect, low-latency localization has been achieved via two interacting filters: a RIP that uses inertial measurements only, and a sensor data fuser that performs sensor fusion of all sensor inputs. In an aspect, a benefit of the RIP is that the low-latency, high-accuracy estimate of the object state can be computed on a low-cost embedded processor. Specifically, by conceiving a mechanization that exploits certain algebraic structure of the object kinematic equations, the computational effort to incorporate sensor fusion updates is reduced by approximately 10 times in some implementations.

By putting equations for integrating IMU measurements to update estimates of the object attitude, velocity, and position into practice (“mechanizing” the equations), it is usually necessary to make a tradeoff between accuracy and computational cost, so there is no single standard “mechanization.”

Object navigation is a closed-loop control process. A closed-loop process requires appropriate gain and phase of the feedback in order to maintain stability. Uncompensated delay can lead to loss of stability in a closed-loop control system. Thus, there is a desire for INS solutions to have very low latency.

In an aspect, the present disclosure provides a highly-efficient computational approach for combining low-latency inertial data from an IMU with delayed measurements from aiding sensors, to produce an overall solution with low latency, low computational cost, and high position accuracy.

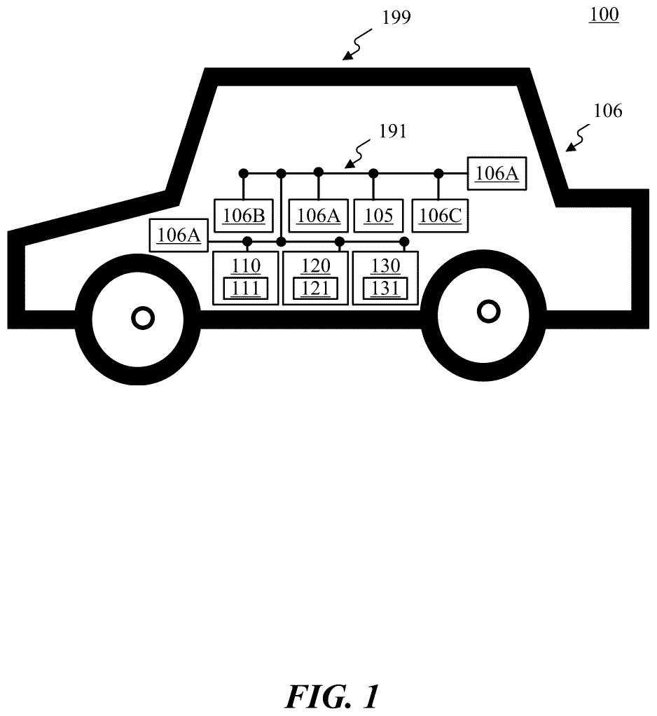

Referring to FIG. 1, an example inertial navigation system (INS) 100 is shown, in accordance with an exemplary aspect. In an aspect, the INS 100 is included in a vehicle 199. While the INS 100 is illustrated as being included in a vehicle 199, it is to be appreciated that the INS 100 may be deployed in any object that will move, such as, but not limited to, a robot, a toy, a plane, a helicopter, an unmanned aerial vehicle, virtual reality (VR) glasses/headgear, and so forth. Thus, items that are autonomous (autonomous vehicles, autonomous toys, etc.) and other items that are non-autonomous (non-autonomous vehicles, non-autonomous toys, VR glass/headgear) may be used. Hence, items under their own power (vehicles) and well as worn items (VR glasses/headgear) having motion imparted on them by another object may be substituted for vehicle 199 in other aspects. The object may have on-board sensors and/or external sensors, depending on the implementation.

The INS 100 includes an inertial measurement unit (IMU) 105 for generating inertial measurement data, aiding sensors 106 for generating additional sensor data, a recursive inertial predictor (RIP) 110 for extrapolating kinematic state, a sensor data fuser 120 for performing sensor fusion, which may include estimating kinematic states and/or sensor errors, and a communications bus 191 communicatively coupling the various components. Other configurations, including redundancies such as extra paths and so forth, may be implemented depending upon the application.

The RIP 110 may be an algorithmic block(s) and/or processing block(s) that extrapolates the kinematic state of the object from the timestamp of the last completed sensor fusion update to the timestamp of the last available IMU sample, using the inertial data for that time period (provided by the IMU 105). The term “last completed sensor fusion update” refers to the current time minus the configured sensor fusion latency, which is typically the latency of the slowest aiding sensor.

In an aspect, the RIP 110 may be an algorithmic block(s) configured to run on one or more processors that are configured to process data separately or in combination using one or more memories. The algorithmic block may be expressed in any computer programming language that accomplishes the specific steps described herein.

In another aspect, the RIP 110 may include hardware including the one or more processors and one or more memories that either separately or in combination function to execute an algorithmic block(s) for predicting object kinematic state.

In yet another aspect, the RIP 110 may be an algorithmic block(s) for predicting an object kinematic state together with one or more processors and one or more memories that are configured to run the algorithmic block(s). The processors may include application specific integrated circuits and or other specially adaptable circuitry for predicting object kinematic state.

In the description of one or more processors and one or more memories, it is to be appreciated that any sets between them that can be formed are envisioned under the teachings of the present disclosure. Thus, a first set type may involve a single processor and a single memory, while a second set type may involve two or more processors and/or two or more memories operating cooperatively. In an aspect, a respective set of processors may be assigned to each aiding sensor 106 and to the IMU 105. For example, each of the IMU 105 and each of the aiding sensors 106 may have assigned thereto a respective set of processors. In an aspect, the assignments of sets is dynamically adjustable to suit the needs of the user such as in the case of more speed to a result and other considerations (e.g., adding or removing respective processors and corresponding memories, e.g., configured to process particular ones of the aiding sensors 106 and/or IMU 105).

In an aspect, and for the sake of illustration, the RIP 110 may be implemented by at least a first set of one or more processors 111, the sensor data fuser 120 may be implemented by a second set of one or more processors 121, and a controller 130 for implementing various vehicle control functions responsive to the outputs of the RIP 110 and the sensor data fuser 120 may be implemented by a third set of one or more processors 131. In an aspect, the first set of one or more processors 111 and the second set of one or more processors 121 are included in a same set or form a same set of processors. In another aspect, different groups of processors may be used, with or without overlap. In an aspect, the third set of one or more processors 131 may be included in a same set or form a set of processors as the first set of one or more processors 111 and/or the second set of one or more processors 121. In an aspect, the third set of one or more processors 131 may include processors in various vehicle control systems including steering, braking, accelerating, stability, lighting, and so forth.

In an aspect, object kinematic state (position, velocity and attitude) is estimated by fusing measurements from a 6 degrees of freedom (DOF) IMU 105 and aiding sensors 106. In an aspect, the aiding sensors 106 include wheel speed sensors 106A, global satellite navigation system (GSNS) position fix determining sensors 106B, and video cameras 106C. The aiding sensors 106 may be disposed within, on, and/or external to an object, depending upon the implementation and the underlying functionality of the sensor. Aiding sensors 106 measuring items internal to an object such as a steering angle or throttle monitor for a vehicle may be disposed within the vehicle. On the other hand, an aiding sensor 106 such as a camera may be disposed in, on, and/or external to the vehicle.

The IMU 105 measures specific forces (i.e., accelerations) and rotations relative to the world frame. Strapdown inertial navigation is a technique in which an IMU is rigidly affixed to a moving vehicle. By sensing the forces and rotations experienced by the IMU 105, and fusing these measurements with measurements from aiding sensors 106 present on the vehicle 199 such as wheel speed sensors 106A, or fixes from a global satellite navigation system (GSNS) 106B, the strapdown INS maintains an estimate of the kinematic state (orientation or “attitude,” velocity, and position) of the vehicle 199 as described in further detail herein.

In an aspect, the latency of the IMU 105 may be approximately 1 ms. However, in an aspect, some or all of the aiding sensors 106 have substantially higher latencies, in some cases up to 250 ms. In principle, there can be no upper limit on the latency. Rather, more memory is allocated to the queues and larger pose errors are accepted due to IMU noise/bias in order to accommodate larger latencies. Thus, the preceding values are merely illustrative, and other values may be used.

In an aspect, the various sensor measurements are processed by the sensor data fuser 120 in the order of their true measurement time. Thus, measurements that are communicated to the sensor data fuser 120 with lower latency are held back to allow measurements that arrive with higher latency to be processed first, in the correct order of the true measurement time. Other approaches to perform sensor fusion with out-of-sequence measurements exist, but these suffer from reduced accuracy or high computational requirements. The approach of fusing measurements in order of true measurement time has the highest accuracy, but the longest latency. For the overall system to achieve the desired latency specification, the sensor data fuser 120 is paired with an inertial-only predictor block (the RIP 110) that processes measurements or samples from the IMU 105 immediately as the measurements or samples become available.

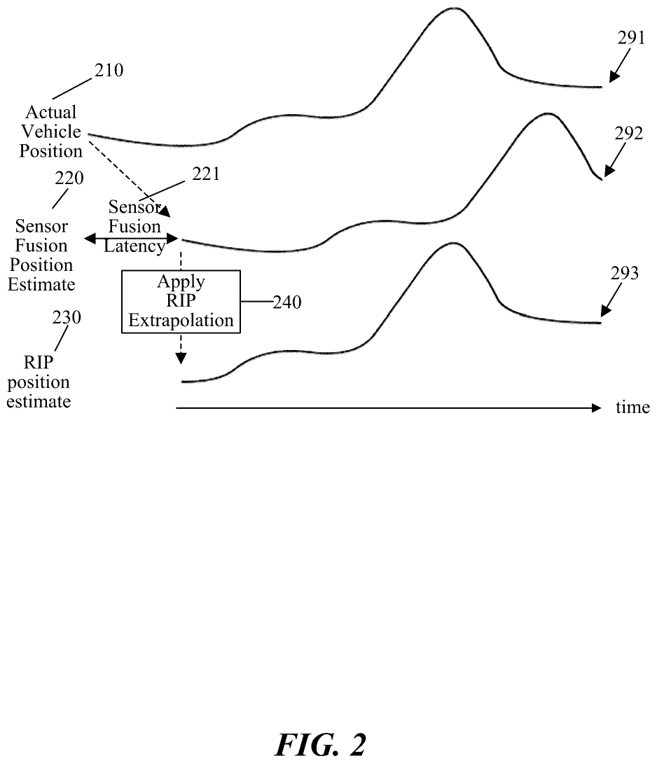

Referring to FIG. 2, example plots over time of actual vehicle positions 210 relative to sensor data fuser vehicle position estimates 220 and RIP extrapolated vehicle position estimates 230 are shown, in accordance with an exemplary aspect. It should be noted that “sensor data fuser” vehicle position estimates 220 may also be referred to as sensor data “fusion” vehicle position estimates, or fusion data.

The top plot 291 shows actual vehicle positions 210 over time. For example, this plot may represent the lateral position of a vehicle within the lane of a roadway over time.

The middle plot 292 shows sensor data fuser vehicle position estimates 220 over time and their corresponding latency 221 relative to actual vehicle positions 210. For example, the sensor fusion latency 221 may be from 100-250 ms.

The bottom plot 293 shows the RIP extrapolated vehicle position estimates 230 made by the RIP 110 over time.

Note that 291 and 293 all aligned in time, which indicates that the RIP extrapolated vehicle position estimates 230 are available with low latency. For example, the RIP estimate latency may be close the IMU measurement latency of 1 ms. The low latency output provided by the RIP extrapolated vehicle position estimates 230 is more suitable for autonomous control of a vehicle steering, such as keeping vehicle 199 centered in the lane of a roadway, than is the high latency output sensor data fuser vehicle position estimates 220 from the sensor fuser.

As shown FIG. 2, the timing of results from the system involving RIP 110 and sensor fuser 120 is characterized by two latency times. To obtain kinematic state predictions with the lowest latency, it is advantageous to configure the first latency time (latency of the RIP) to be as small as possible. That is the RIP should calculate its results and communicate them to the vehicle controller 130 without any added delay, as soon as new inertial data arrives from IMU 105. It is advantageous to configure the second latency time (how long sensor fuser 120 waits for arrival of late aiding sensor measurements), to be larger than the first latency time (latency of the RIP), but it is not possible to wait an indefinite amount of time. Based on an analysis of the latencies of the measurements received from IMU 105 and aiding sensors 106, a greatest typical latency time of the aiding sensors, for example the 95^{th} percentile of observed aiding sensor measurement latencies, may be determined, and the sensor fuser 120 may be configured to use this second latency time.

In an aspect, the RIP 110 extrapolates the sensor data fuser vehicle position estimates 220, using a kinematic state extrapolation 240 that is based on the inertial data for the extrapolation time horizon between the timestamp of the last sensor fusion output and the latest IMU measurement. The extrapolation time horizon is on the order of 100-250 ms. When a new inertial data sample from the IMU 105 becomes available, the extrapolation horizon is extended. When the sensor data fuser 120 completes an update, the base state from which extrapolation starts is stepped forward, thereby contracting the extrapolation time horizon. The base state corresponds to timestamp, position, velocity and attitude attributes of an object.

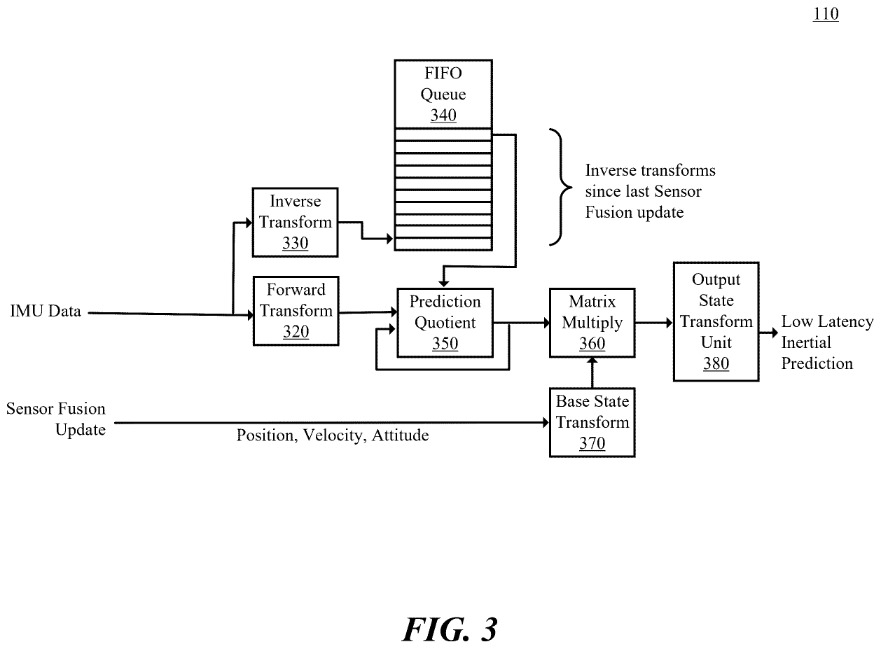

Referring to FIG. 3, an example recursive inertial predictor (RIP) 110 of FIG. 1 is shown, in accordance with an exemplary aspect.

The RIP 110 has 2 inputs: IMU data and base kinematic state (position, velocity, and attitude) of the vehicle at a base time, which may be the high-latency result from a sensor fuser, and a single output providing the low-latency vehicle kinematic state estimate.

The core of the RIP 110 is the prediction quotient unit 350, which maintains the transformation between the vehicle kinematic state at the start time and end time of the extrapolation time horizon.

The base state transform unit 370, matrix multiply unit 360, and output state transform unit 380 work together to perform the kinematic state extrapolation 240 from the high-latency base state reported by the sensor fuser to the low-latency inertial prediction, using the kinematic transformation output by the prediction quotient unit 350.

The remainder of the components: forward transform unit 320, inverse transform unit 330, and tracking FIFO queue 340, work to preprocess the IMU data into a form convenient for maintaining the prediction quotient by two kinds of recursive update operations performed by the prediction quotient unit 350, which we describe next.

The first kind of update occurs when new IMU data is communicated to the RIP. In this kind of update, the time horizon of inertial prediction is extended. The IMU sample data is processed by forward transform unit 320 to compute a corresponding forward kinematic transformation that is then used to recursively update the prediction quotient unit 350. By recursive, we mean that the new state of the prediction quotient unit 350 depends on the prior state of the prediction quotient unit 350 and the forward transform unit 320 output. Then matrix multiply unit 360 operates on the prediction from prediction quotient unit 350 and the output of base state transform unit 370. Finally, output state transform unit 380 extracts and communicates a new low-latency kinematic state prediction.

The new IMU data is also processed by inverse transform unit 330, and the result is stored in tracking FIFO queue 340 for use later.

The second kind of update occurs when the sensor fuser 120 communicates updated base values for the position, velocity, and attitude to the RIP 110. In this kind of update, the time horizon of inertial prediction is shortened (contracted). Prediction quotient unit 350 is recursively updated by drawing inverse transform elements out of the FIFO queue 340, so that the prediction quotient accurately reflects the shortened extrapolation time horizon. All elements in the tracking FIFO queue 340 that antedate the timestamp of the new sensor fuser result should be removed from the tracking FIFO queue 340 and applied to the prediction quotient.

The two-ended FIFO-like updating process of the prediction quotient advantageously reduces the computational effort required for RIP 110 to incorporate new updates from the sensor data fuser 120. Specifically, the step-up in the base state of the RIP 110 is computed without reprocessing all the inertial data corresponding to the prediction horizon due to the ability of the RIP 110 to back out a subset of IMU measurements in linear time, such as the measurements that arrived between two prior sensor fusion updates. The computational savings are most significant if the prediction horizon is many times larger than the sensor fusion update timestep. In experiments, the prediction horizon was typically 250 ms, and the time between sensor fusion updates was 10 ms, so aspects of the present disclosure can represent about a 25× reduction in computation required to incorporate each sensor fusion update. This eliminates spikes in required computational throughput and as a result the RIP 110 can be advantageously implemented on a low-cost embedded processor.

The computational advantage of maintaining the kinematic state prediction by recursively extending or contracting an extrapolation horizon can be understood by an analogy with moving-average filtering. Suppose there is an infinite series of samples x[n], n=0 . . . and the intent is to compute a moving average of K samples:

$$y [ n ] = 1 / K * ( x [ n ] + x [ n - 1 ] + x [ n - 2 ] + … x [ n - K + 1 ] )$$

The brute force approach is for each output sample n to sum up K input numbers. The more efficient approach is to do this recursively. Notice that y[n] differs from y[n−1] by only two terms as follows:

$$y [ n - 1 ] = 1 / K * ( x [ n - 1 ] + x [ n - 2 ] + x … x [ n - K + 1 ] + x [ n - K ] )$$

So, if y[n−1] has previously been computed, y[n] can be computed as:

$$y [ n ] = y [ n - 1 ] + 1 / K * ( x [ n ] - x [ n - K ] )$$

By analogy, the processing used according to various aspects to keep the low-latency state prediction in RIP 110 up to date only requires making recursive adjustments to the prediction quotient based on inertial data samples at either end of the extrapolation time horizon. There is no need to reprocess all the intermediate inertial data samples.

“Mechanization” is a term used in the field of inertial navigation to describe how the physical equations of motion are implemented in a computational device.

In a preferred mechanization, the kinematic state of the vehicle 199 (attitude, velocity, and position), and transformations (motions) between different kinematic states, are represented within the RIP 110 by 5×5 matrices. However, other dimensioned matrices as described herein may also be used. The special structure of the matrices used confers an algebraic Lie group structure on this state representation: states and transitions between states can be represented in the same form. Also importantly, every group element has an inverse, which makes possible the operation of inverse transform unit 330 and the recursive updating of the prediction quotient by prediction quotient unit 350 described previously.

In an aspect, preprocessing each sample of the low-latency inertial data occurs only once upon an arrival at the first set of one or more processors to trigger an initial computation of an algebraic Lie Group transition matrix such that subsequent updates to the object orientation by the sensor data fuser use the initial computation of the algebraic Lie Group transition matrix as an estimate of orientation without a re-computation of the algebraic Lie Group transition matrix. In this way, computational resource can be saved, and a speed to result is increased.

In an aspect, each of the 5×5 matrices is constructed to include a respective entry for a 3×3 rotation matrix, a 3×1 velocity vector, a 3×1 position vector, and a timestamp. The 3×3 rotation matrix relates to x, y, and z axes. In this way, kinematic state information can be stored in a representative data structure.

In an aspect, the algebraic Lie Group transition matrices are constructed responsive to corrected low-latency inertial data. In an aspect, the intent is to track the orientation, velocity and position of a system (vehicle, robot, toy, and so forth). In an aspect, the algebraic Lie group transition matrices are constructed based on low-latency inertial data that has been corrected to removes any known biases such as system (measurement sensor, etc.) biases and those resulting from Gravity.

In an aspect, 5×5 matrices are used to represent two related, but separate concepts. First, the 5×5 matrices are used to represent the state (configuration) of a system at a particular instant in time. Second, the 5×5 matrices are used to represent incremental motions that occurs over some time horizon St. In this way, the entirety of the information representative of an object kinematic state does not need to be saved for every time instant of a time period, instead using an object kinematic state at a particular time instant of the time period and incremental deviations that can be combined with the object kinematic state at the particular time instant to compute a current object kinematic state for other time instants of the time period.

Both concepts use a matrix M with the following structure:

$$M = [ \begin{matrix}R & v & p \\ 0 & 1 & t \\ 0 & 0 & 1\end{matrix} ]$$

$$R denotes a 3 \times 3 attitude or rotation matrix$$

$$v denotes a 3 \times 1 velocity vector or velocity increment$$

$$p denotes a 3 \times 1 position vector or position increment$$

$$t denotes a timestamp$$

A matrix of this form may be variously referred to as “kinematic state matrix”, “transition matrix”, “transform matrix”, or “prediction quotient”, depending on the context.

Continuing to refer to FIG. 3 and FIG. 1 for context, the function of base state transform unit 370 is to construct a 5×5 matrix M from the timestamp, position, velocity and attitude attributes of the base state communicated to the RIP 110 by the sensor fuser 120. The function of the output state transform unit 380 is to extract the timestamp, position, velocity and attitude attributes from the 5×5 matrix representation used internally to the RIP 110 so that they may be communicated to the vehicle controller 130.

If all the entries are written out, then matrix M would look something like this (5x5):

$$M = [ \begin{matrix}{R}_{11} & {R}_{12} & {R}_{13} & {v}_{1} & {p}_{1} \\ {R}_{21} & {R}_{22} & {R}_{23} & {v}_{2} & {p}_{2} \\ {R}_{31} & {R}_{32} & {R}_{33} & {v}_{3} & {p}_{3} \\ 0 & 0 & 0 & 1 & t \\ 0 & 0 & 0 & 0 & 1\end{matrix} ]$$

A general incremental motion may be represented as follows:

$$T = [ \begin{matrix}δ R & δ v & δ p \\ 0 & 1 & δ t \\ 0 & 0 & 1\end{matrix} ]$$

For the particular case of a time period corresponding to the IMU measurement period, the forward transform unit 320 computes an incremental motion that is related to the calibrated IMU measured values by:

$$transition {T}_{k} = T ( \tilde{ω} , \tilde{a} ) = [ \begin{matrix}exp ( {\tilde{ω}}_{x} dt ) & \tilde{a} dt & \frac{1}{2} \tilde{a} {dt}^{2} \\ 0 & 1 & dt \\ 0 & 0 & 1\end{matrix} ]$$

where \tilde{ω} are the calibrated rotation rates (bias, scale factor and Earth rotation removed) and ã are the calibrated accelerations (bias, scale factor and gravity removed). exp( ) means matrix exponential. Depending on the IMU sample period, in any aspect, exp( ) can be approximated by its one or two term Taylor series, or it can be the exact solution based on sines and cosines of certain angles. In an aspect, the exact sine/cosines formulas may be used. In other aspects, less expensive formulas may be suitable. Such consideration may be based on speed and accuracy tradeoffs, for example.

There are closed form equations for the inverse matrix of an incremental motion as follows:

$${T}^{- 1} = [ \begin{matrix}δ {R}^{T} & - δ {R}^{T} δ v & - δ {R}^{T} ( δ p - δ v * δ t ) \\ 0 & 1 & - δ t \\ 0 & 0 & 1\end{matrix} ]$$

For the particular case of a time period corresponding to the IMU measurement period, the inverse transform unit 330 computes an inverse matrix from the calibrated IMU data as follows:

$${T}_{0}^{- 1} ( \tilde{ω} , \tilde{a} ) = [ \begin{matrix}{exp ( {\tilde{ω}}_{x} dt )}^{T} & - {exp ( {\tilde{ω}}_{x} dt )}^{T} \tilde{a} dt & {exp ( {\tilde{ω}}_{x} dt )}^{T} \frac{1}{2} \tilde{a} {dt}^{2} \\ 0 & 1 & - dt \\ 0 & 0 & 1\end{matrix} ]$$

With the setup above, multiplying a state matrix M on the right by a transition Tₖ implements dead-reckoning as follows:

$$M [ k + 1 ] = M [ k ] \cdot {T}_{k}$$

In navigation, dead-reckoning is the process of calculating the current position of a moving object by using a previously determined position, or fix, and incorporating estimates of speed, heading (or direction), and elapsed time. That is, dead reckoning (DR) is a navigation technique that estimates an object's current position using its previous location and information about its velocity and direction. DR uses a vehicle's known starting position, its speed and direction, and how long it's maintained that velocity to calculate its new position.

If the dead-reckoning equations are written out for the subblocks of state matrix M, alternative but equivalent mechanizations are obtained as follows:

$$M = [ \begin{matrix}R & v & p \\ 0 & 1 & t \\ 0 & 0 & 1\end{matrix} ]$$

The equations for a single update step of the blocks of state matrix M are as follows:

$$t [ k + 1 ] = t [ k ] + dt$$

$$R [ k + 1 ] = R [ k ] \cdot exp ( {\tilde{ω}}_{\times } dt )$$

$$v [ k + 1 ] = v [ k ] + R [ k ] \tilde{a} dt$$

$$p [ k + 1 ] = p [ k ] + v [ k ] dt + \frac{1}{2} R [ k ] \tilde{a} {dt}^{2}$$

When multiplications on the right are chained by Tₖ, the prediction quotient Q is obtained as follows: Q(tₖ, tₖ₊₁)=Tₖ

For example: Q(t₀, t₇)=T₀ T₁ T₂ T₃ . . . T₆

The dead-reckoning formula is used to extend the prediction horizon as more inertial samples are recursively accumulated (predicting over a longer horizon since the last base state update).

The equations for recursively updating the prediction quotient to extend the extrapolation horizon (equivalent to Q(t₀, tₖ₊₁)=Q(t₀, tₖ)·Mₖ) are essentially the same as the above for state matrix M, but some separate symbols should be defined for the incremental rotation, velocity change, and position change as follows:

$$Q = [ \begin{matrix}Θ & Δ v & Δ p \\ 0 & 1 & Δ t \\ 0 & 0 & 1\end{matrix} ]$$

$$Δ t ( {t}_{0} , {t}_{k + 1} ) = Δ t ( {t}_{0} , {t}_{k} ) + dt$$

$$Θ ( {t}_{0} , {t}_{k + 1} ) = Θ ( {t}_{0} , {t}_{k} ) + exp ( {\tilde{ω}}_{\times } dt )$$

$$Δ v ( {t}_{0} , {t}_{k + 1} ) = Δ v ( {t}_{0} , {t}_{k} ) + Θ ( {t}_{0} , {t}_{k} ) \tilde{a} dt$$

$$Δ p ( {t}_{0} , {t}_{k + 1} ) = Δ p ( {t}_{0} , {t}_{k} ) + Δ v ( {t}_{0} , {t}_{k} ) dt + \frac{1}{2} Θ ( {t}_{0} , {t}_{k} ) \tilde{a} {dt}^{2}$$

Next, the equations for moving up the base time (e.g., from T₀ to T₁) are described, for example when sensor data fuser 120 completes a correction step and provides a new base object kinematic state estimate to RIP 110. In the described 5×5 matrix mechanization, the equations for updating the prediction quotient are as follows:

$$Q ( {t}_{0} , {t}_{k} ) = {T}_{0} {T}_{1} {T}_{2} {T}_{3} … {T}_{k - 1}$$

$$Q ( {t}_{1} , {t}_{k} ) = {T}_{1} {T}_{2} {T}_{3} … {T}_{k - 1} = {T}_{0}^{- 1} \cdot ( {T}_{0} {T}_{1} {T}_{2} {T}_{3} … {T}_{k - 1} ) = {T}_{0}^{- 1} Q ( {t}_{0} , {t}_{k} )$$

Now, an alternative formulation is given in terms of equations for updating each of the blocks of the prediction quotient matrix Q to remove the effect of the oldest sample in the time-horizon:

$$Q = [ \begin{matrix}Θ & Δ v & Δ p \\ 0 & 1 & Δ t \\ 0 & 0 & 1\end{matrix} ]$$

$$Q ( {t}_{1} , {t}_{k} ) = {T}_{0}^{- 1} ( \tilde{ω} , \tilde{a} ) \cdot Q ( {t}_{0} , {t}_{k} )$$

$$Δ t ( {t}_{1} , {t}_{k} ) = Δ t ( {t}_{0} , {t}_{k} ) - dt$$

$$Θ ( {t}_{1} , {t}_{k} ) = {exp ( {\tilde{ω}}_{x} dt )}^{T} \cdot Θ ( {t}_{0} , {t}_{k} )$$

$$Δ v ( {t}_{1} , {t}_{k} ) = {exp ( {\tilde{ω}}_{x} dt )}^{T} \cdot Δ v ( {t}_{0} , {t}_{k} ) - {exp ( {\tilde{ω}}_{x} dt )}^{T} \tilde{a} dt = {exp ( {\tilde{ω}}_{x} dt )}^{T} \cdot ( Δ v ( {t}_{0} , {t}_{k} ) - \tilde{a} dt )$$

$$Δ p ( {t}_{1} , {t}_{k} ) = {exp ( {\tilde{ω}}_{x} dt )}^{T} \cdot Δ p ( {t}_{0} , {t}_{k} ) - {exp ( {\tilde{ω}}_{x} dt )}^{T} \cdot \tilde{a} dt Δ t ( {t}_{0} , {t}_{k} ) + {exp ( {\tilde{ω}}_{x} dt )}^{T} \cdot \frac{1}{2} \tilde{a} {dt}^{2} = {exp ( {\tilde{ω}}_{x} dt )}^{T} \cdot ( Δ p ( {t}_{0} , {t}_{k} ) - \tilde{a} dt ( Δ t ( {t}_{0} , {t}_{k} - \frac{1}{2} dt ) )$$

In an aspect, the intent is to track the orientation, velocity and position of a system (vehicle, robot, toy, and so forth). In a more limited aspect, the low-latency estimates of just a subset of the state may be computed. One example would be the case where interest is only in tracking the orientation of a system, and not its position and velocity. A second example would be a system that tracked orientation and velocity (but not position). Other examples/variations are possible from the preceding three-member group. In an alternative aspect, the rotation/angular motion aspects are quantified using quaternions instead of direction cosine matrices.

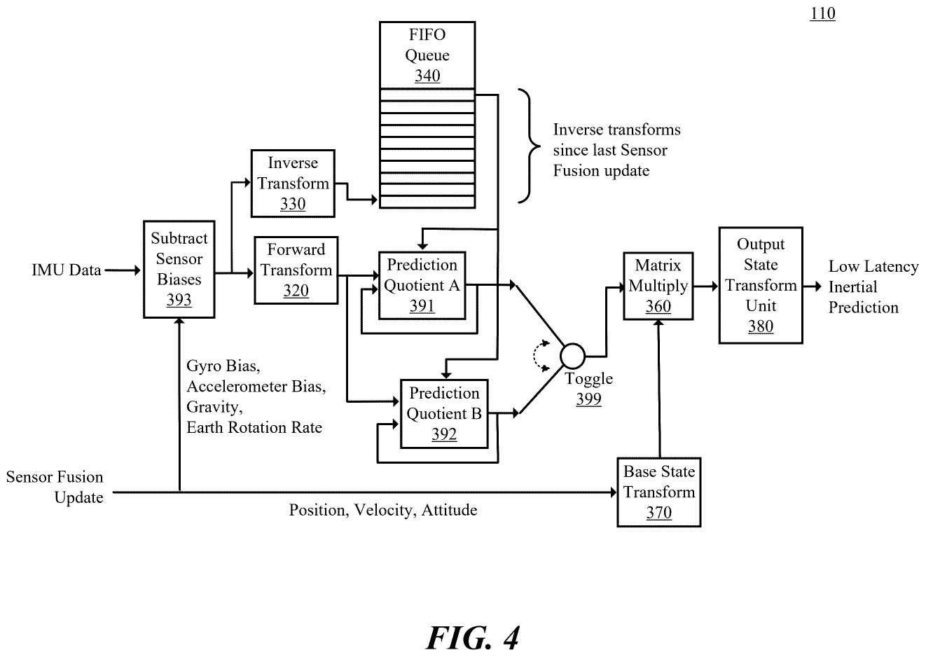

Referring to FIG. 4, a more elaborated variant of the recursive inertial predictor (RIP) 110 of FIG. 3 is shown, in accordance with an exemplary aspect.

The variant of RIP 110 shown in FIG. 4 differs from RIP 110 of FIG. 3 in including the following additional elements: subtract sensor biases unit 393; prediction quotient unit A 391; prediction quotient unit B 392; and toggle 399.

In this variant, the associated sensor fuser 120 is configured to estimate inertial sensor scale factors, biases, and an effect of gravity, in addition to the kinematic states of the target object. This enables the effects of gravity and other biases such as sensor biases to be removed from the inertial data. The subtract sensor biases unit 393 takes IMU data, gravity data, and sensor bias estimates (as sensor fusion updates) as inputs. The output from the bias and gravity subtraction unit, namely an IMU sample with gravity effects and sensor bias accounted for/removed (hereinafter “processed IMU sample”), is provided to the forward transform matrix unit 320 and the inverse transform matrix unit 330.

In the exemplary aspect shown in FIG. 4, the RIP 110 uses a ping-pong resetting concept to avoid numerical error in the output solution. Over long periods of operation, the prediction quotient matrix Q(tᵢ, tⱼ) that implements dead reckoning over the latency horizon from tᵢ to tⱼ will accumulate a numerical error. Numerical error is the consequence of the rounding operations that occur when performing calculations with finite-precision arithmetic as used in all digital computers, for example 32-bit floating-point numbers. Transform matrices can be copied and parallel copies use to enhance system performance by minimizing error accumulation over a plurality of update cycles.

Although in principle, terms are applied to the prediction quotient matrix Q on the right, and later those terms are removed by multiplying by the inverse (quotient) factors on the left, in practice, the finite-precision effects cause the quotients not to exactly cancel out the original factors. These errors grow over time.

The following approach can help to prevent the growth of numerical error in the RIP output state predictions.

Prediction quotient unit A 391 and prediction quotient unit B 392 respectively provide two separate prediction quotients Q_{A}(tᵢ, tⱼ) and Q_{B}(tᵢ, tⱼ). The toggle 399 determines which prediction quotient A or B is provided as input to matrix multiply unit 360 to be combined with the base state matrix M_{SDF}.

When prediction quotient unit A 391 is active, the output of matrix multiply unit 360 is:

$${M}_{output} ( {t}_{j} ) = {M}_{SDF} ( {t}_{i} ) \cdot {Q}_{A} ( {t}_{i} , {t}_{j} )$$

When prediction quotient unit B 392 is active, the output of matrix multiply unit 360 is:

$${M}_{output} ( {t}_{j} ) = {M}_{SDF} ( {t}_{i} ) \cdot {Q}_{B} ( {t}_{i} , {t}_{j} )$$

When either quotient is inactive, it can be reset to the identity. For example, if factor B is inactive, factor B can be reset as follows:

$${Q}_{B} \to {Q}_{B} ( {t}_{j} , {t}_{j} ) = {I}_{5 \times 5} = [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} ]$$

After it is reset, prediction quotient Q_{B} no longer covers the time-horizon from the sensor fusion time tᵢ to tⱼ. Thus, prediction quotient Q_{B} cannot yet be used to predict the output. Prediction quotient Q_{B} is maintained in the same way as described before, with the exception that if sensor fusion updates occur that cause quotient terms to be removed from the tracking FIFO 340, these quotient terms are not applied to prediction quotient Q_{B} if their timestamps are prior to tⱼ. If a quotient term is pulled from the tracking FIFO queue 340 with a timestamp after tⱼ, then the quotient term is applied to prediction quotient Q_{B} as normal, and this indicates that prediction quotient Q_{B} has caught up to cover the entire latency horizon and is ready to use to predict the output. The system can now make the prediction quotient Q_{B} the active factor and reset the prediction quotient Q_{A}.

This approach utilizes a second prediction factor to be maintained as each new IMU sample and sensor fusion update message arrives. This approximately doubles the number of computations required per time sample. However, the same tracking FIFO queue 340 can serve both factors, so the increase in memory usage is small.

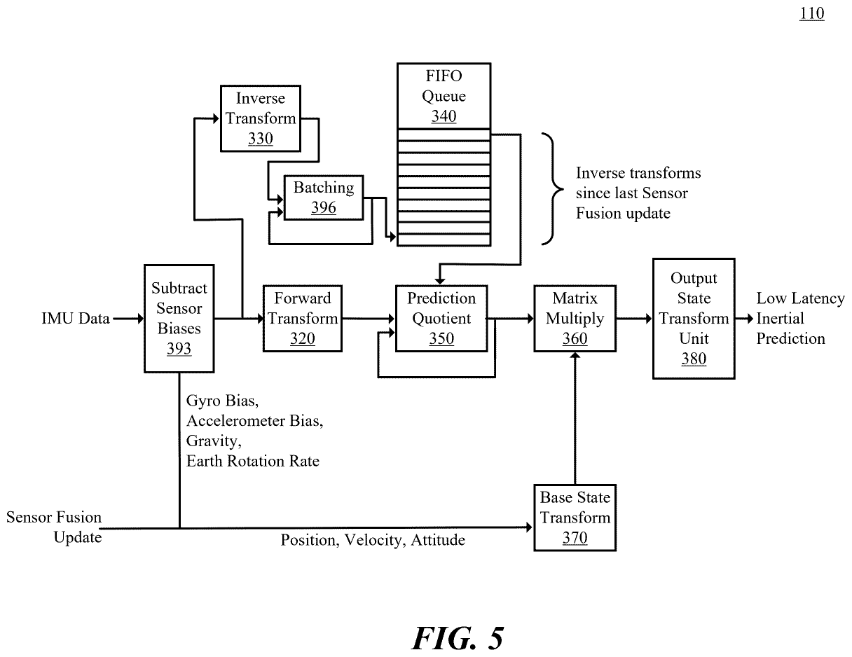

Referring to FIG. 5, another variant of the recursive inertial predictor (RIP) 110 of FIG. 3 is shown, in accordance with an exemplary aspect.

The variant of RIP 110 shown in FIG. 5 differs from RIP 110 of FIG. 3 in including the following additional elements: subtract sensor biases unit 393; and batching unit 396.

The subtract sensor biases unit 393 shown in FIG. 5 operates as described above with respect to FIG. 4.

An implementation of a sample-batching variant performed with respect to the batching unit 396 will now be described. A high IMU sample rate (e.g., 1 kHz) should be used at the RIP input to reduce error in the integrated solution from coning and sculling effects. Not all user applications require state estimates to be output at the full IMU sample rate.

In an aspect of the IMU concept, the low-latency state estimate was maintained within the RIP 110 with a time-resolution equal to the IMU sample time, which could be 1 ms for an IMU sample rate of 1 kHz. In a full time-resolution concept, there is one item (e.g., inverse transform matrix) in the tracking FIFO queue 340 of the RIP 110 for each time sample of the latency horizon. Depending on the latency of the other sensors (the aiding sensors) 106, this may utilize a large amount of memory for the tracking FIFO queue 340 which may be unsuitable for an implementation on a microcontroller.

In an aspect, a microcontroller-based implementation of the RIP 110 with no operating system or real-time operating system is used for low-cost and high reliability operation.

Due to the memory constraints of the target microcontroller, the implementation was changed to reduce the number of separate items stored in the tracking FIFO queue 340. This is done by batching several inverse transition matrices into a quotient and then writing the quotient and the last timestamp to the tracking FIFO queue 340. For example, if the IMU sample period is 1 ms, and the sensor data fuser 120 updates occur regularly once every 20 ms, then a batch of 20 transitions is a good choice that reduces buffer memory utilization by the factor 20 and yet still maintains full system performance. To maintain maximum tracking accuracy, the messages from the sensor data fuser 120 to the RIP 110 should occur only at times corresponding to the batch end timestamps. Several approaches can be used to achieve this correspondence. In one approach, the IMU samples are batched and integrated before being provided to the sensor data fuser 120; this assures that the batches used in the sensor data fuser 120 and the RIP 110 are consistent. In a second approach, all IMU samples are passed to the sensor data fuser 120 individually, but those IMU samples that correspond to the end of an RIP batch can be identified as such by setting a flag in the data passed to the sensor data fuser 120. In an aspect, the RIP 110 is configured such that batching unit 396 of RIP 110 sets the flag to indicate the end of a batch of the low-latency inertial data.

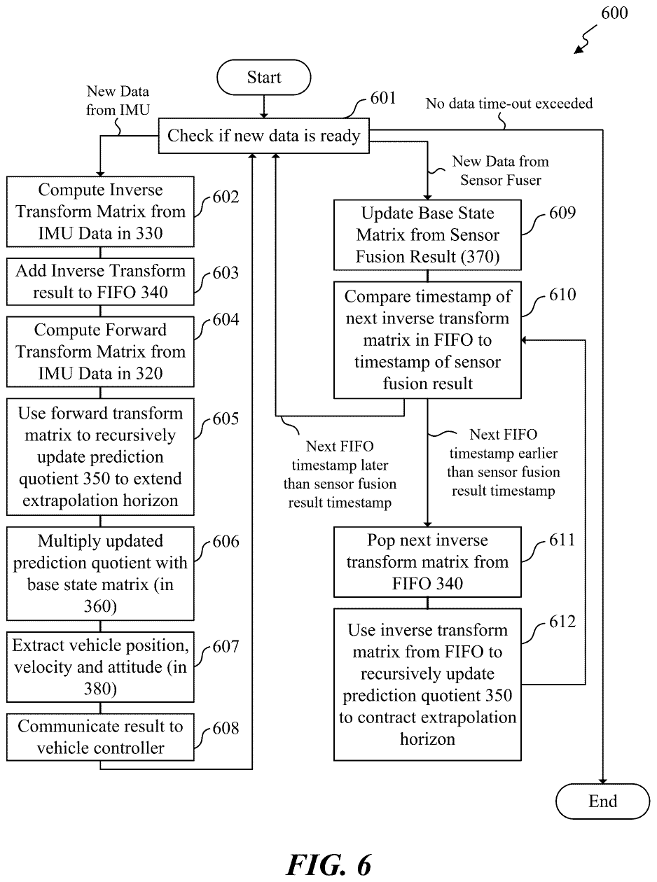

Referring to FIG. 6, an example method 600 for operation of the RIP 110 of FIG. 3 is shown, in accordance with an exemplary aspect.

At block 601, the method 600 includes checking to determine if new data is ready. If new IMU data is ready, then method 600 proceeds to block 602. If new sensor fusion data from sensor fuser 120 is ready, then method 600 proceeds to block 609. If a timer having a predetermined duration expires since any last data was received, then a “no new data timeout” occurs, and then method 600 is terminated, but may also be temporarily delayed until a next iteration (e.g., performed after a prespecified time period), or so forth.

At block 602, the method 600 includes computing, by inverse transform unit 330, an inverse transform matrix from the IMU data. The inverse transform matrix is computed using the formula described above with respect to FIG. 3.

At block 603, the method 600 includes adding the inverse transform computed by inverse transform unit 330 to the back of tracking FIFO queue 340.

At block 604, the method 600 includes computing, by forward transform unit 320, a forward transform matrix from the IMU data. The IMU data is processed by forward transform unit 320 to compute a corresponding forward kinematic transformation that is then used to recursively update the prediction quotient unit 350. By recursive, this means that the new state of the prediction quotient unit 350 depends on the prior state of the prediction quotient unit 350 and the forward transform unit 320 output.

At block 605, the method 600 includes using, by prediction quotient unit 350, the forward transform matrix to recursively update a prediction quotient to extend an extrapolation horizon. The prediction quotient relates to a difference in one or more of the kinematic states (orientation or “attitude,” velocity, and position) of the object at the first time versus at the second time. This is the first of two types of updates performed to update the prediction quotient to correspond to the time horizon of the initial extrapolation. This first kind of update (in block 605) recursively extends the time horizon of the inertial prediction by multiplying the stored value of the quotient matrix on the right by the forward transform matrix computed from a sample of inertial data in 604, and overwriting the stored quotient matrix with the resulting product. The second kind of update, performed by block 612, recursively contracts the time horizon of the inertial prediction, as described later.

At block 606, the method 600 includes multiplying, by matrix multiply unit 360, the stored prediction quotient in 350 with a base state matrix to obtain a product. The base state matrix includes information indicative of one or more of position, velocity, and attitude of the target object at the first time. After the operation of block 606, the product includes information indicative of one or more of position, velocity, and attitude of a target object at the second time.

At block 607, the method 600 includes extracting, by output state transform unit 380, one or more of position, velocity, and attitude of a target object (e.g., a vehicle) from the product of block 606 to obtain an inertially-extrapolated sensor fusion result.

At block 608, the method 600 includes communicating, by output state transform unit 380, the inertially-extrapolated sensor fusion result (one or more of position, velocity, and attitude of the target object) to a controller (e.g., a vehicle controller, a robot controller, etc.). The result comprises a new low-latency prediction of the kinematic state of the object, which is beneficial for control of the object. The method 600 then returns to block 601 to check if new data is ready.

Alternatively or in addition, as mentioned above, in the case where block 601 determines new data from the sensor fuser is ready, then at block 609, the method 600 includes updating, by base state transform unit 370, a base state matrix from the sensor fusion result. In an aspect, the base state transform unit 370 updates a 5×5 matrix M from the timestamp, position, velocity and attitude attributes of the base state communicated to the RIP 110 by the sensor fuser 120.

At block 610, the method 600 includes comparing a timestamp of a next inverse transform matrix in tracking FIFO queue 340 to a timestamp of the sensor fusion result. If the timestamp of the next inverse transform matrix in tracking FIFO queue 340 is later than the timestamp of the sensor fusion result, then method 600 returns to block 601. If the timestamp of the next inverse transform matrix in tracking FIFO queue 340 is earlier than or equal to the timestamp of the sensor fusion result, then method 600 proceeds to block 611. In an aspect, the comparison of the timestamps may be computed in prediction quotient unit 350.

At block 611, the method 600 includes popping a next inverse transform matrix from tracking FIFO queue 340. Inverse transforms were added to the back of tracking FIFO queue 340 in block 603. Popping refers to removing an element from the front of the tracking FIFO queue 340. Here, a next inverse transform matrix is removed from the front of the tracking FIFO queue 340.

At block 612, the method 600 includes using, by prediction quotient unit 350, the popped inverse transform matrix from tracking FIFO queue 340 to recursively update the prediction quotient to contract the extrapolation horizon. The quotient matrix is updated by multiplying the stored value of the quotient matrix by the inverse transform matrix on the left and overwriting the stored quotient matrix with the result. Block 612 then returns to block 610 to compare the timestamp of a next inverse transform matrix in FIFO queue 340 to the timestamp of the sensor fusion result.

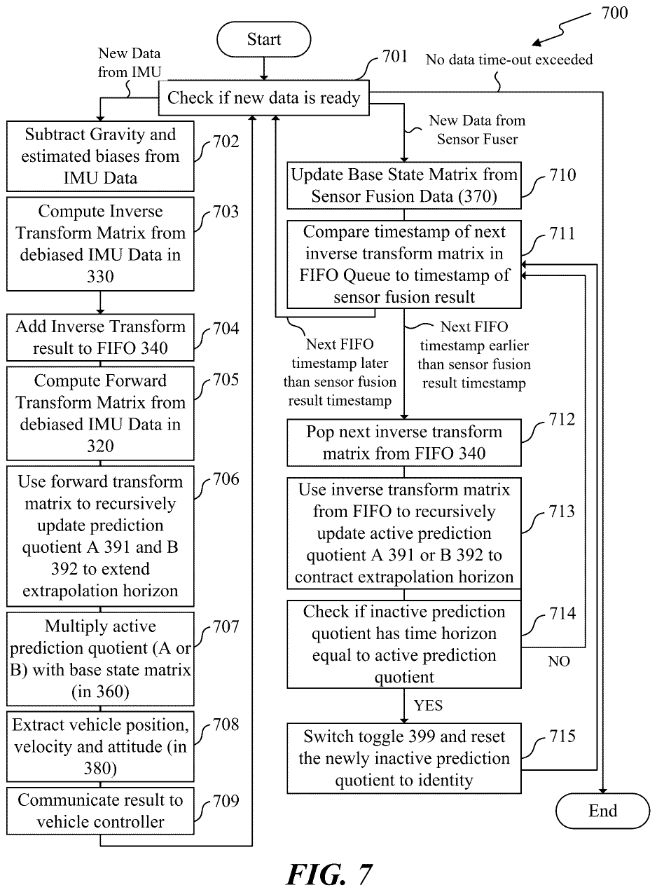

Referring to FIG. 7, an example method 700 for operation of the RIP 110 of FIG. 4 is shown, in accordance with an exemplary aspect.

At block 701, the method 700 includes checking to determine if new data is ready. If new IMU data is ready, then method 700 proceeds to block 702. If new sensor fusion data is ready, then method 700 proceeds to block 710. If a timer having a predetermined duration expires since any last data was received, then a “no new data timeout” event occurs, and then method 700 is terminated, but may also be temporarily delayed until a next iteration (e.g., performed after a prespecified time period), or so forth.

At block 702, the method 700 includes subtracting, by subtract sensor biases unit 393, Gravity and estimated biases from the IMU data to obtain debiased IMU data. The output from the subtract sensor biases unit 393, namely an IMU sample with gravity effects and sensor bias accounted for/removed, is provided to the forward transform matrix unit 320 and the inverse transform matrix unit 330 for use in blocks 703 and 705.

At block 703, the method 700 includes computing, by inverse unit 330, an inverse transform matrix from the debiased IMU Data.

At block 704, the method 700 includes adding the inverse transform computed by inverse transform unit 330, the inverse transform matrix to the back of tracking FIFO queue 340.

At block 705, the method 700 includes computing, by forward transform unit 320, a forward transform matrix from the debiased IMU data. The debiased IMU data is processed by forward transform unit 320 to compute a corresponding forward kinematic transformation that is then used to recursively update the prediction quotient unit 350. By recursive, we mean that the new state of the prediction quotient unit 350 depends on the state of the prediction quotient unit 350 and the forward transform unit 320 output.

At block 706, the method 700 includes using, by prediction quotient unit A 391 and prediction quotient unit B 392, a forward transform matrix from forward transform unit 320 to recursively update a prediction quotient A from prediction quotient unit A 391 and a prediction quotient B from prediction quotient unit B 392 to extend an extrapolation horizon. The prediction quotients relate to a difference in one or more of the kinematic states (orientation or “attitude,” velocity, and position) of the object at the first time versus at the second time. This is the first of two types of updates performed to update the prediction quotient to correspond to the time horizon of the initial extrapolation. This is the first of two types of updates performed to update prediction quotient A and prediction quotient B to correspond to the time horizon of the initial prediction. The first kind of update (in block 706) recursively extends the time horizon of the initial prediction by multiplying the stored values of the quotient matrices A and B by the forward transform matrix computed from a sample of debiased inertial data in 705, and overwriting the stored quotient matrix with the resulting product. The second kind of update, performed by block 713, recursively contracts the time horizon, as described later.

At block 707, the method 700 includes multiplying, by matrix multiply unit 360, the active prediction quotient (A or B) with a base state matrix to obtain a product. The base state matrix includes information indicative of one or more of position, velocity, and attitude of the target object at the first time. After the operation of block 707, the product includes information indicative of one or more of position, velocity, and attitude of a target object at the second time.

At block 708, the method 700 includes extracting, by output state transform unit 380, a one or more of position, velocity and attitude of a target object (e.g., a vehicle) from the product to obtain an inertially-extrapolated sensor fusion result.

At block 709, the method 700 includes communicating, by output state transform unit 380, the inertially-extrapolated sensor fusion result (one or more of position, velocity, and attitude of the target object) to a controller (e.g., a vehicle controller, a robot controller, etc.). The result comprises a new low-latency prediction of the kinematic state of the object, which is beneficial for control of the object. The method 700 then returns to block 701 to determine if new data is ready.

Alternatively or in addition, as mentioned above, in the case where block 701 determines new data from the sensor fuser is ready, then at block 710, the method 700 includes updating, by base state transform unit 370, a base state matrix from the sensor fusion result. In an aspect, the base state transform unit 370 of RIP 110 updates a 5×5 matrix M from the timestamp, position, velocity and attitude attributes of the base state communicated to RIP 110 by sensor data fuser 120.

At block 711, the method 700 includes comparing a timestamp of a next inverse transform matrix in tracking FIFO queue 340 to a timestamp of the sensor fusion result. If the timestamp of the next inverse transform matrix in tracking FIFO queue 340 is later than the timestamp of the sensor fusion result, then method 700 returns to block 701. If the timestamp of the next inverse transform matrix in tracking FIFO queue 340 is earlier than or equal to the timestamp of the sensor fusion result, then method 700 returns to block 711. In an aspect, the comparison of the timestamps may be computed in prediction quotient unit A 391 and prediction quotient unit B 392.

At block 712, the method 700 includes popping a next inverse transform matrix from tracking FIFO queue 340. Inverse transforms were added to the back of tracking FIFO queue 340 in block 704.

At block 713, the method 700 includes using the inverse transform matrix from tracking FIFO queue 340 to recursively update active prediction quotient A from prediction quotient unit A 391 or prediction quotient B from prediction quotient unit B 392 to contract extrapolation horizon. This second update (the first update was performed at block 706) contracts the time horizon of the inertial prediction by multiplying the stored value of the active quotient matrix A or B by an inverse transform matrix computed on the left and overwriting the stored quotient matrix A or B with the result. Only the active prediction quotient A or B, as selected by toggle 399, is updated in this block.

At block 714, the method 700 includes checking if inactive prediction quotient has a time horizon equal to the active prediction quotient A or B. If yes (the inactive prediction quotient has a time horizon equal to the active prediction quotient A or B), then the method 700 proceeds to block 715. Otherwise, if no, then the method 700 returns to block 711 to compare the timestamp of a next inverse transform matrix in FIFO queue 340 to the timestamp of the sensor fusion result.

At block 715, in the case where the inactive prediction quotient has a time horizon equal to the active prediction quotient, then the method 700 includes switching toggle 399 and resetting the newly inactive prediction quotient to identity (e.g., an identity matrix). The toggle 399 determines which prediction quotient A or B is provided as input to matrix multiply unit 360 to be combined with the base state matrix. Method 700 then returns to block 711 to compare the timestamp of a next inverse transform matrix in FIFO queue 340 to the timestamp of the sensor fusion result.

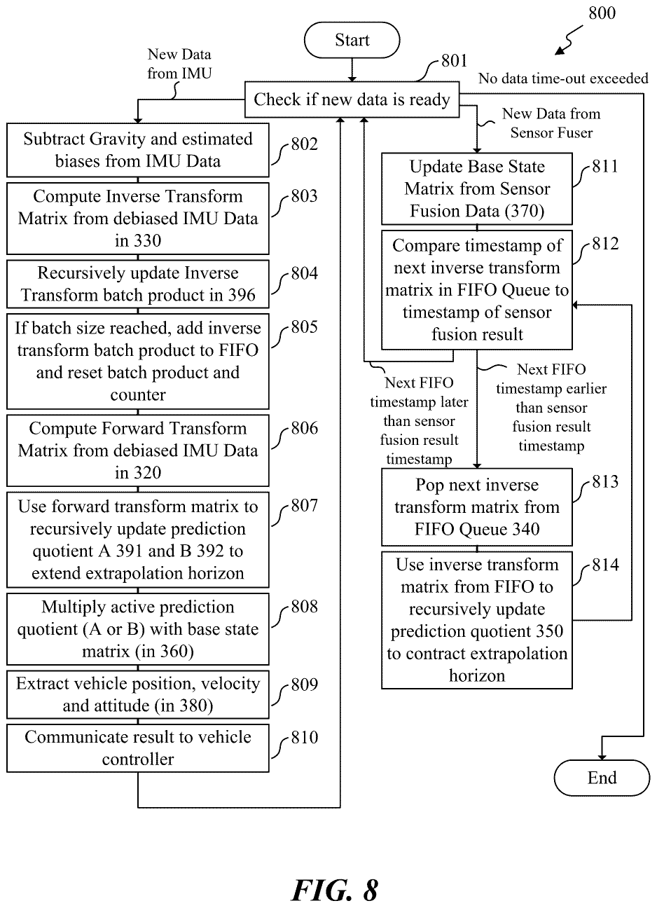

Referring to FIG. 8, an example method 800 for the RIP 110 of FIG. 5 is shown, in accordance with an exemplary aspect.

At block 801, the method 800 includes checking to determine if new data is ready. If new IMU data is ready, then method 700 proceeds to block 802. If new sensor fusion data is ready, then method 700 proceeds to block 811. If a “no new data timeout” is exceeded, then method 800 is terminated, but may also be temporarily delayed until a next iteration (e.g., performed after a prespecified time period), or so forth.

At block 802, the method 800 includes subtracting, by subtract sensor biases unit 393, Gravity and estimated biases from the IMU data to obtain debiased IMU data. The output from the subtract sensor biases unit 393, namely an IMU sample with gravity effects and sensor bias accounted for/removed, is provided to the forward transform matrix unit 320 and the inverse transform matrix unit 330 for use in blocks 803 and 806.

At block 803, the method 800 includes computing, by inverse unit 330, an inverse transform matrix from the debiased IMU data.

At block 804, the method 800 includes recursively updating, by batching unit 396, an inverse transform batch product. The recursive updating involves batching several inverse transition matrices into a quotient.

At block 805, the method 800 includes, if a batch size is reached, adding the inverse transform batch product to the back of tracking FIFO queue 340 and resetting the inverse transform batch product and a counter.

At block 806, the method 800 includes computing, by forward transform unit 320, a forward transform matrix from the debiased IMU data. The debiased IMU data is processed by forward transform unit 320 to compute a corresponding forward kinematic transformation that is then used to recursively update the prediction quotient unit 350. By recursive, we mean that the new state of the prediction quotient unit 350 depends on the prior state of the prediction quotient unit 350 and the forward transform unit 320 output.

At block 807, the method 800 includes using forward transform matrix to recursively update prediction quotient unit 350 to extend an extrapolation horizon. The time horizon of the initial prediction is extended by multiplying the stored value of the quotient matrix on the right by the forward transform matrix computed from a sample of debiased inertial data in 806, and overwriting the stored quotient matrix with the resulting product.

At block 808, the method 800 includes multiplying, by matrix multiply unit 360, the store prediction quotient in 350 with a base state matrix to obtain a product.

At block 809, the method 800 includes extracting, by output state transform unit 380, a one or more of position, velocity and attitude of a target object (e.g., a vehicle) from the product of block 808 to obtain an inertially-extrapolated sensor fusion result.

At block 810, the method 800 includes communicating, by output state transform unit 380, the inertially-extrapolated sensor fusion result (one or more of position, velocity, and attitude of the target object) to a controller (e.g., a vehicle controller, a robot controller, etc.). The sensor fusion result comprises a new low-latency prediction of the kinematic state of the object, which is beneficial for the control of the object. The method 800 then returns to block 801 to determine if new data is ready.

Alternatively or in addition, as mentioned above, in the case where block 801 determines new data from the sensor fuser is ready, then at block 811, the method 800 includes updating, by base state transform unit 370, a base state matrix from the sensor fusion result. In an aspect, base state transform unit 370 updates a 5×5 matrix M from the timestamp, position, velocity and attitude attributes of the base state communicated to RIP 110 by sensor fuser 120.

At block 812, the method 800 includes comparing a timestamp of a next inverse transform matrix in tracking FIFO queue 340 to a timestamp of the sensor fusion result. If the timestamp of the next inverse transform matrix in tracking FIFO queue 340 is later than the timestamp of the sensor fusion result, then method 800 returns to block 801. If the timestamp of the next inverse transform matrix in tracking FIFO queue 340 is earlier than or equal to the timestamp of the sensor fusion result, then method 800 returns to block 812. In an aspect, the comparison of the timestamps may be computed in prediction quotient unit 350.

At block 813, the method 800 includes popping, by prediction quotient unit 350, a next inverse transform matrix from tracking FIFO queue 340. Inverse transforms were added to the back of tracking FIFO queue 340 after batching in block 805.

At block 814, the method 800 includes using, by prediction quotient unit 350, the popped inverse transform matrix from tracking FIFO queue 340 to recursively update the prediction quotient to contract the extrapolation horizon. The quotient matrix is updated by multiplying the stored value of the quotient matrix by the inverse transform matrix on the left and overwriting the stored quotient matrix with the result. Block 814 then returns to block 812 to compare the timestamp of the next inverse transform matrix in FIFO queue 340 to the timestamp of the sensor fusion result.

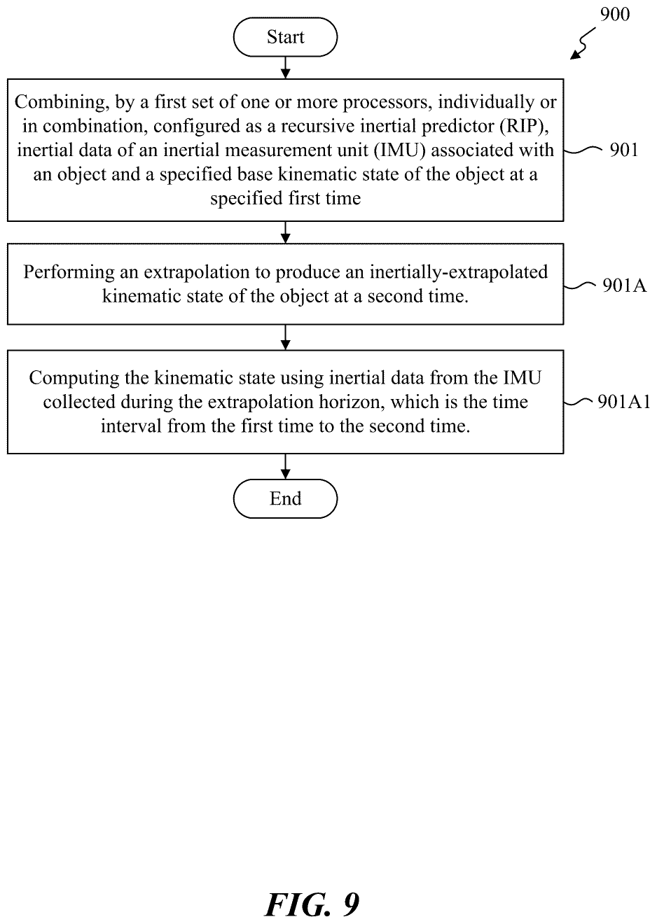

Referring to FIG. 9, an example method 900 for efficiently obtaining low-latency inertially-extrapolated kinematic state estimates of a target object is shown, in accordance with an exemplary aspect.

At block 901, the method 900 includes combining, by a first set of one or more processors, individually or in combination, configured as a recursive inertial predictor (RIP) 110, inertial data of an inertial measurement unit (IMU) associated with an object and a specified base kinematic state of the object at a specified first time.

In an aspect, block 901 may include block 901A.

At block 901A, the method 900 includes performing an extrapolation to produce an inertially-extrapolated kinematic state of the object at a second time.

In an aspect, block 901A may include block 901A1.

At block 901A1, the method 900 incudes computing the kinematic state using inertial data from the IMU collected during the extrapolation horizon, which is the time interval from the first time to the second time. Depending on the aspect, inertial extrapolation is performed by prediction quotient unit 350 or prediction quotient unit A 391 and/or prediction quotient unit B 392.

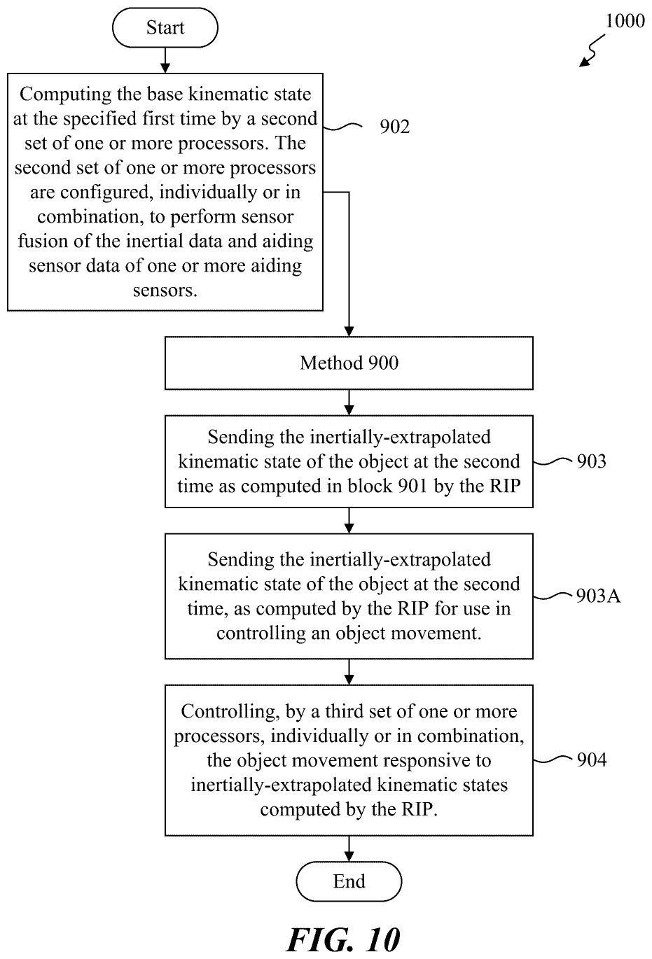

Referring to FIG. 10, an example method 1000 for controlling object movement responsive to inertially-extrapolated kinematic state estimates is shown, in accordance with an exemplary aspect.

In an aspect, method 1000 may include block 902.

At block 902, the method 1000 includes computing the base kinematic state at the specified first time by a second set of one or more processors. In an aspect, the second set of one or more processors are, individually or in combination, configured as a sensor data fuser. In an aspect, the second set of one or more processors are configured as a sensor data fuser 120 to perform sensor data fusion of the inertial data and aiding sensor data of one or more aiding sensors. In an aspect, the sensor data fuser 120 is configured to compute the base kinematic state at the specified first time. In any aspect, the base kinematic state includes one or more of a base orientation, a base position, and a base velocity.

At block 903, the method 1000 includes sending the inertially-extrapolated kinematic state of the object at the second time as computed in block 901 by RIP 110. In an aspect, the inertially-extrapolated kinematic state of the object at the second time is sent to a controller or third set of one or more processors.

In an aspect, block 903 may include block 903A.

At block 903A, the method 1000 includes sending the inertially-extrapolated kinematic state of the object at the second time, as computed by RIP 110, for use in controlling an object movement. In an aspect, RIP 110 sends the inertially-extrapolated kinematic state of the object at the second time to a controller or a third set of one or more processors for use in controlling an object movement. In an aspect, the controller or third set of one or more processors correspond to a vehicle or robot control system directed to steering, motion (forward, reverse), and so forth. For example, RIP 110 sends the inertially-extrapolated kinematic state to, e.g., a controller or third set of one or more processors configured to control object movement. In an aspect, the object is a vehicle, and the inertially-extrapolated kinematic state is used to determine how to control the vehicle (e.g., change the orientation, position, etc.). In an aspect, vehicle control may be performed for obstacle avoidance by being combined with information from a camera system capable of capturing images of objects (e.g., other vehicles, pedestrians, shrubbery, etc.) proximate to the subject object (e.g., the vehicle).

At block 904, the method 1000 further includes controlling, by a third set of one or more processors, individually or in combination, the object movement responsive to inertially-extrapolated kinematic states computed by RIP 110. In an aspect, controlling the object movement may involve braking, accelerating, steering, lighting (e.g., emergency lights, turning or braking signals, etc.), stability control, and so forth. In an aspect, the inertially-extrapolated kinematic states include one or more of an inertially-extrapolated orientation, an inertially-extrapolated position, and an inertially-extrapolated velocity.

Aspects of the present disclosure include one or any combination of the following clauses.

Clause 1. A method, comprising: combining, by a first set of one or more processors, individually or in combination, configured as a recursive inertial predictor (RIP), inertial data of an inertial measurement unit (IMU) associated with an object and a specified base kinematic state of the object at a specified first time, wherein the combining includes performing an extrapolation to produce an inertially-extrapolated kinematic state of the object at a second time, wherein the extrapolation includes recursively extending or contracting an extrapolation horizon.

Clause 2. The method in accordance with clause 1, wherein the base kinematic state at the specified first time is computed by a second set of one or more processors, individually or in combination, configured as a sensor data fuser, to perform sensor fusion of the inertial data and aiding sensor data of one or more aiding sensors.

Clause 3. The method in accordance with any preceding clauses, further comprising sending the inertially-extrapolated kinematic state of the object at the second time, as computed by the RIP.

Clause 4. The method in accordance with any preceding clauses, wherein inertially-extrapolated kinematic states of the object, as computed by the RIP, are sent for use in controlling an object movement.

Clause 5. The method in accordance with any preceding clauses, further comprising controlling, by a third set of one or more processors, individually or in combination, the object movement responsive to inertially-extrapolated kinematic states computed by the RIP.

Clause 6. The method in accordance with any preceding clauses, further comprising: configuring a second latency time of a result of the sensor fuser to be equal to or greater than a greatest typical latency time of the aiding sensors; and configuring a first latency time of a result of the RIP to be less than the second latency time.

Clause 7. The method in accordance with any preceding clauses, further comprising configuring the first latency time to be without any added delay.

Clause 8. The method in accordance with any preceding clauses, further comprising: estimating, by the sensor data fuser, a past object kinematic state and one or more past IMU measurement error parameters and communicating, from the sensor data fuser to the RIP, the past object kinematic state and the one or more past IMU measurement error parameters to adjust a current value of the inertial data in the RIP, thereby producing a sample of adjusted inertial data.

Clause 9. The method in accordance with any preceding clauses, further comprising performing the method by an inertial navigation system (INS) that comprises the IMU configured to generate the inertial data and the aiding sensors configured to generate the aiding sensor data.

Clause 10. The method in accordance with any preceding clauses, further comprising processing the inertial data in time-aligned batches by the RIP and the sensor data fuser.

Clause 11. The method in accordance with any preceding clauses, further comprising configuring the RIP to individually receive samples of the inertial data and set a flag to indicate an end of a batch of the inertial data and trigger a selection of a next batch of the inertial data.

Clause 12. The method in accordance with any preceding clauses, further comprising reducing a number of separate items stored in a tracking first-in first-out (FIFO) queue used by the RIP by batching several inverse transform matrices into a quotient and then writing the quotient and a last timestamp to the tracking FIFO queue.

Clause 13. The method in accordance with any preceding clauses, further comprising recursively updating a quotient transition matrix that represents an inertial prediction of object motion from a first object kinematic state at a first time to a second object kinematic state at a second time, by (1) extending a time horizon of the inertial prediction by multiplying the transition matrix by a forward transform matrix computed from a sample of the inertial data, and (2) contracting the time horizon of the inertial prediction by multiplying the transition matrix by an inverse transform matrix computed from the sample of inertial data.

Clause 14. The method in accordance with any preceding clauses, wherein the sample of inertial data is the sample of adjusted inertial data.

Clause 15. The method in accordance with any preceding clauses, further comprising using a two-ended first-in first-out (FIFO) queue in the RIP to store inverse transforms associated with past inertial measurements.

Clause 16. The method in accordance with any preceding clauses, further comprising preventing accumulation of numerical errors in a quotient matrix used by the RIP by using two parallel copies of the quotient matrix that are reset in an alternating fashion such that a computation overhead of a plurality of resets is amortized over a plurality of update cycles.

Clause 17. The method in accordance with any preceding clauses, further comprising resetting the two parallel copies of the quotient matrix in the alternating fashion to be equal to an identity matrix.

Clause 18. The method in accordance with any preceding clauses, further comprising quantifying at least one of rotation motion aspects and angular motion aspects of the inertial data using quaternions.

Clause 19. The method in accordance with any preceding clauses, wherein an updated kinematic state of the object comprises an object orientation, an object velocity, and an object position.

Clause 20. A system, comprising: a first set of one or more processors, individually or in combination, configured as a recursive inertial predictor (RIP), to combine inertial data of an inertial measurement unit (IMU) associated with an object and a specified base kinematic state of the object at a specified first time, wherein a combining includes performing an extrapolation to produce an inertially-extrapolated kinematic state of the object at a second time, wherein the extrapolation includes recursively extending or contracting an extrapolation horizon.

Clause 21. The system in accordance with clause 20, further comprising a second set of one or more processors, individually or in combination, configured as a sensor data fuser to compute the base kinematic state at the specified first time by performing sensor fusion of the inertial data and aiding sensor data of one or more aiding sensors.

Clause 22. The system in accordance with any preceding clauses, wherein the RIP is further configured to send the inertially-extrapolated kinematic state of the object at the second time.

Clause 23. The system in accordance with any preceding clauses, wherein inertially-extrapolated kinematic states of the object, as computed by the RIP, are sent for use in controlling an object movement.

Clause 24. The system in accordance with any preceding clauses, further comprising a third set of one or more processors, individually or in combination, configured to control the object movement responsive to inertially-extrapolated kinematic states computed by the RIP.

Clause 25. The system in accordance with any preceding clauses: wherein a second latency time of a result of the sensor fuser is configured to be equal to or greater than a greatest typical latency time of the aiding sensors; and wherein a first latency time of a result of the RIP is configured to be less than the second latency time.

Clause 26. The system in accordance with any preceding clauses, wherein the first latency time is configured to be without any added delay.

Clause 27. The system in accordance with any preceding clauses, wherein the sensor data fuser is further configured to: estimate a past object kinematic state and one or more past IMU measurement error parameters and communicate, to the RIP, the past object kinematic state and the one or more past IMU measurement error parameters to adjust a current value of the inertial data in the RIP, thereby producing a sample of adjusted inertial data.

Clause 28. The system in accordance with any preceding clauses, wherein the system is an inertial navigation system (INS) that comprises the IMU configured to generate the inertial data and the aiding sensors configured to generate the aiding sensor data.

Clause 29. The system in accordance with any preceding clauses, wherein the RIP and the sensor data fuser are further configured to process the inertial data in time-aligned batches.

Clause 30. The system in accordance with any preceding clauses, wherein the RIP is further configured to individually receive samples of the inertial data and set a flag to indicate an end of a batch of the inertial data and trigger a selection of a next batch of the inertial data.

Clause 31. The system in accordance with any preceding clauses, wherein the RIP reduces a number of separate items stored in a tracking first-in first-out (FIFO) queue used by the RIP by batching several inverse transform matrices into a quotient and then writing the quotient and a last timestamp to the tracking FIFO queue.

Clause 32. The system in accordance with any preceding clauses, wherein the first set of one or more processors are further configured to recursively update a quotient transition matrix that represents an inertial prediction of object motion from a first object kinematic state at a first time to a second object kinematic state at a second time, by (1) extending a time horizon of the inertial prediction by multiplying the transition matrix by a forward transform matrix computed from a sample of the inertial data, and (2) contracting the time horizon of the inertial prediction by multiplying the transition matrix by an inverse transform matrix computed from the sample of inertial data.

Clause 33. The system in accordance with any preceding clauses, wherein the sample of inertial data is the sample of adjusted inertial data.

Clause 34. The system in accordance with any preceding clauses, wherein the RIP uses a two-ended first-in first-out (FIFO) queue to store inverse transforms associated with past inertial measurements.

Clause 35. The system in accordance with any preceding clauses, wherein the RIP is configured to prevent an accumulation of numerical errors in a quotient matrix used by the RIP by using two parallel copies of the quotient matrix that are reset in an alternating fashion such that a computation overhead of a plurality of resets is amortized over a plurality of update cycles.

Clause 36. The system in accordance with any preceding clauses, wherein the two parallel copies of the quotient matrix are reset in the alternating fashion to be equal to an identity matrix.

Clause 37. The system in accordance with any preceding clauses, wherein at least one of rotation motion aspects and angular motion aspects of the inertial data are quantified using quaternions.

Clause 38. The system in accordance with any preceding clauses, wherein an updated kinematic state of the object comprises an object orientation, an object velocity, and an object position.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any device protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method, comprising:
combining, by a first set of one or more processors, individually or in combination, configured as a recursive inertial predictor (RIP), inertial data of an inertial measurement unit (IMU) associated with an object and a specified base kinematic state of the object at a specified first time, wherein the combining includes performing an extrapolation to produce an inertially-extrapolated kinematic state of the object at a second time, wherein the extrapolation includes recursively extending or contracting an extrapolation horizon.

2. The method in accordance with claim 1, wherein the base kinematic state at the specified first time is computed by a second set of one or more processors, individually or in combination, configured as a sensor data fuser, to perform sensor fusion of the inertial data and aiding sensor data of one or more aiding sensors.

3. The method in accordance with claim 2, further comprising sending the inertially-extrapolated kinematic state of the object at the second time, as computed by the RIP.

4. The method in accordance with claim 3, wherein inertially-extrapolated kinematic states of the object, as computed by the RIP, are sent for use in controlling an object movement.

5. The method in accordance with claim 4, further comprising controlling, by a third set of one or more processors, individually or in combination, the object movement responsive to inertially-extrapolated kinematic states computed by the RIP.

6. The method in accordance with claim 2, further comprising:
configuring a second latency time of a result of the sensor fuser to be equal to or greater than a greatest typical latency time of the aiding sensors; and
configuring a first latency time of a result of the RIP to be less than the second latency time.

7. The method in accordance with claim 6, further comprising configuring the first latency time to be without any added delay.

8. The method in accordance with claim 2, further comprising:
estimating, by the sensor data fuser, a past object kinematic state and one or more past IMU measurement error parameters and
communicating, from the sensor data fuser to the RIP, the past object kinematic state and the one or more past IMU measurement error parameters to adjust a current value of the inertial data in the RIP, thereby producing a sample of adjusted inertial data.

9. The method in accordance with claim 2, further comprising performing the method by an inertial navigation system (INS) that comprises the IMU configured to generate the inertial data and the aiding sensors configured to generate the aiding sensor data.

10. The method in accordance with claim 2, further comprising processing the inertial data in time-aligned batches by the RIP and the sensor data fuser.

11. The method in accordance with claim 10, further comprising configuring the RIP to individually receive samples of the inertial data and set a flag to indicate an end of a batch of the inertial data and trigger a selection of a next batch of the inertial data.

12. The method in accordance with claim 10, further comprising reducing a number of separate items stored in a tracking first-in first-out (FIFO) queue used by the RIP by batching several inverse transform matrices into a quotient and then writing the quotient and a last timestamp to the tracking FIFO queue.

13. The method in accordance with claim 1, further comprising recursively updating a quotient transition matrix that represents an inertial prediction of object motion from a first object kinematic state at a first time to a second object kinematic state at a second time, by (1) extending a time horizon of the inertial prediction by multiplying the transition matrix by a forward transform matrix computed from a sample of the inertial data, and (2) contracting the time horizon of the inertial prediction by multiplying the transition matrix by an inverse transform matrix computed from the sample of inertial data.

14. The method in accordance with claim 13, wherein the sample of inertial data is the sample of adjusted inertial data.

15. The method in accordance with claim 14, further comprising using a two-ended first-in first-out (FIFO) queue in the RIP to store inverse transforms associated with past inertial measurements.

16. The method in accordance with claim 1, further comprising preventing accumulation of numerical errors in a quotient matrix used by the RIP by using two parallel copies of the quotient matrix that are reset in an alternating fashion such that a computation overhead of a plurality of resets is amortized over a plurality of update cycles.

17. The method in accordance with claim 16, further comprising resetting the two parallel copies of the quotient matrix in the alternating fashion to be equal to an identity matrix.

18. The method in accordance with claim 1, further comprising quantifying at least one of rotation motion aspects and angular motion aspects of the inertial data using quaternions.

19. The method in accordance with claim 1, wherein an updated kinematic state of the object comprises an object orientation, an object velocity, and an object position.

20. A system, comprising:
a first set of one or more processors, individually or in combination, configured as a recursive inertial predictor (RIP), to combine inertial data of an inertial measurement unit (IMU) associated with an object and a specified base kinematic state of the object at a specified first time, wherein a combining includes performing an extrapolation to produce an inertially-extrapolated kinematic state of the object at a second time, wherein the extrapolation includes recursively extending or contracting an extrapolation horizon.

21. The system in accordance with claim 20, further comprising a second set of one or more processors, individually or in combination, configured as a sensor data fuser to compute the base kinematic state at the specified first time by performing sensor fusion of the inertial data and aiding sensor data of one or more aiding sensors.

22. The system in accordance with claim 21, wherein the RIP is further configured to send the inertially-extrapolated kinematic state of the object at the second time, and wherein inertially-extrapolated kinematic states of the object, as computed by the RIP, are sent for use in controlling an object movement.

23. The system in accordance with claim 22, further comprising a third set of one or more processors, individually or in combination, configured to control the object movement responsive to inertially-extrapolated kinematic states computed by the RIP.

24. The system in accordance with claim 21, wherein the sensor data fuser is further configured to:
estimate a past object kinematic state and one or more past IMU measurement error parameters and
communicate, to the RIP, the past object kinematic state and the one or more past IMU measurement error parameters to adjust a current value of the inertial data in the RIP, thereby producing a sample of adjusted inertial data.

25. The system in accordance with claim 21, wherein the system is an inertial navigation system (INS) that comprises the IMU configured to generate the inertial data and the aiding sensors configured to generate the aiding sensor data.

26. The system in accordance with claim 21, wherein the RIP and the sensor data fuser are further configured to process the inertial data in time-aligned batches, wherein the RIP is further configured to individually receive samples of the inertial data and set a flag to indicate an end of a batch of the inertial data and trigger a selection of a next batch of the inertial data, and wherein the RIP reduces a number of separate items stored in a tracking first-in first-out (FIFO) queue used by the RIP by batching several inverse transform matrices into a quotient and then writing the quotient and a last timestamp to the tracking FIFO queue.

27. The system in accordance with claim 20, wherein the first set of one or more processors are further configured to recursively update a quotient transition matrix that represents an inertial prediction of object motion from a first object kinematic state at a first time to a second object kinematic state at a second time, by (1) extending a time horizon of the inertial prediction by multiplying the transition matrix by a forward transform matrix computed from a sample of the inertial data, and (2) contracting the time horizon of the inertial prediction by multiplying the transition matrix by an inverse transform matrix computed from the sample of inertial data.

28. The system in accordance with claim 27, wherein the sample of inertial data is the sample of adjusted inertial data, and wherein the RIP uses a two-ended first-in first-out (FIFO) queue to store inverse transforms associated with past inertial measurements.

29. The system in accordance with claim 20, wherein the RIP is configured to prevent an accumulation of numerical errors in a quotient matrix used by the RIP by using two parallel copies of the quotient matrix that are reset in an alternating fashion such that a computation overhead of a plurality of resets is amortized over a plurality of update cycles.

30. The system in accordance with claim 20, wherein at least one of rotation motion aspects and angular motion aspects of the inertial data are quantified using quaternions.

31. The system in accordance with claim 20, wherein an updated kinematic state of the object comprises an object orientation, an object velocity, and an object position.
